(19) United States
(12) Patent Application Publication
(10) Pub. No.: US 2006/0287832 A1
(43) Pub. Date: Dec. 21, 2006

(54) Reduction of the noise content of molecular diagnostic signals

(75) Inventor: William James Gibb, San Anselmo, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/154,183

(22) Filed: Jun. 15, 2005

(51) Int. Cl. G06F 19/00

(52) U.S. Cl. 702/20

(57) ABSTRACT

A method and system for reducing the noise content of molecular diagnostic signals. One or more hybridized microarrays derived from one or more biological samples. Gene expression data is obtained from the microarray and is filtered utilizing a signal transduction model. By incorporating the use of numerical representation of the signal transduction model, errors from measurement and process noise can be reduced.

### GENERAL

The present invention relates to the use of signal transduction pathways to reduce the random noise content of gene expression profiles. In particular, the present invention relates to the reduction of diagnostic error rates associated with clinical applications of gene expression profiling.

Genetic information is stored in the DNA of every cell in the human body. While the human genome contains thousands of genes, only a portion affects the functions of the cells at any given time. Selected gene information from the DNA is transcribed into RNA products, such as messenger RNA (mRNA) molecules, which, in turn, are translated into proteins for use within the cell. This process is known as “gene expression.”

Within the domain of diagnostics, informative genes typically represent some subset of the human genome. DNA microarray technology has been used to identify expression levels of genes in a biological sample. Located on each DNA microarray (also known as a DNA hybridization array) are numerous sites, each of which can selectively bind fluorescently labeled nucleic acid copies of the mRNA molecule. The microarray can be used to collect gene expression level data for hundreds or thousands of genes simultaneously. This is accomplished by using a microarray reader to quantify the amount of labeled nucleic acid bound to specific sites on the microarray.

Within the domain of diagnostics, selected genes typically represent some subset of the human genome. Using significant sample sizes, gene expression profiles have been developed for a variety of conditions. For example, research conducted by Golub, et. al. used gene expression profiles to differentiate between two types of leukemia. Research conducted by Mazzanti et. al. similarly used gene expression profiles for benign and malignant thyroid tumors.

Additionally, modeling techniques have been developed to analyze expression levels. Using these techniques, such as those based on the use of Bayesian networks, researchers have developed models of known signal transduction networks for a variety of different cell types and conditions. Signal transduction is the process by which a cell converts an inputted signal or stimulus into another signal or stimulus. Accordingly, a signal transduction network is any model that represents one or more acts of signal transduction. Thus, a signal transduction network (or signal transduction model) seeks to define the associations between different molecular processes.

Through the use of gene expression modeling, the specificity and sensitivity of clinical diagnostic assays can be improved. For example, gene expression signatures may allow physicians to detect the onset of cancer far earlier than achievable by conventional screening techniques and to increase the confidence with which therapeutic options can be tailored to the individual. Because most cases of cancer arise as a result of multiple molecular defects, gene expression modeling tools applied to cancer would need to sense the expression levels of moderately large families of genes. Although early clinical experience with microarrays suggests that they could form the basis for powerful diagnostic tools, challenges remain before the technology can be successfully transferred from the research laboratory into routine clinical practice.

One of the factors limiting the application of microarrays to a clinical diagnostic setting is their susceptibility to random errors. In large clinical studies, meaningful conclusions may be drawn from noisy data sets because the masking effects of purely random errors are diminished as a consequence of the large sample size. Applying the same noise-prone techniques to an individual diagnosis, however, may be problematic because the false-positive error rates associated with the individual's relatively small sample size may be unacceptable. Error rates of even a few percent may be large enough to deter the adoption of the assay for diagnostic purposes.

### BRIEF SUMMARY

Many disease-specific genes have been identified and their interactions are now being described in signal transduction networks. As noted above, however, noise and other errors implicit in reading gene expression data may limit the effectiveness of gene expression profiling as a diagnostic tool. To address the noise susceptibility and other errors in the collection of gene expression data, the growing knowledge base of molecular mechanisms underlying cancer and other diseases may be used. Through the use of gene expression modeling, the specificity and sensitivity of individual diagnostic assays can be improved.

Measurements of biological activity through multivariate gene expression can be acquired. In addition, biological signal transduction pathways have been emulated as signal transduction networks. By incorporating one or more signal transduction networks into a state estimator, noise in the gene expression measurements may be reduced through filtering. Further, because signal transduction processes are often non-stationary in nature, the signal transduction networks and/or the state estimator (i.e. filter) may be adaptive.

According to some embodiments, a model of pertinent signal transduction pathways can be incorporated into a filtering scheme to improve extraction of gene expression signals from noisy data. By taking advantage of the signal redundancy typically available in multivariate gene expression profiles, the signal-to-noise ratio of key expression signals can be increased.

The presently preferred embodiments apply models of pathways that already characterize a system to extract relatively clean signals from noisy measurements. As such, biological samples may be better utilized within the diagnostic setting. Additionally, the numerical model of the one or more known signal pathways may be also adjusted over time.

In the preferred embodiments, the extraction of signals is accomplished by filtered gene expression vectors received from a microarray reader. The filtering may be accomplished with a Kalman filter outputting a least-squares estimation vector. In this approach, a plurality of microarray samples may be recursively applied to the filter for dynamic state estimation over time and gene expression estimates may be recursively outputted. By using a previously deduced least squares estimator and matrices that numerically model one or more known signal pathways, the filter outputs a vector that estimates the appropriate gene expression values to reduce noise inherent in the measurement and sample preparation processes.

In one aspect, a method for reducing the noise content of molecular diagnostic signals is provided in which gene expression information is read from a microarray and the gene expression information received is filtered using signal transduction model information.

In another aspect, a method for reducing the noise content of molecular diagnostic signals is provided in which gene expression data is obtained from a biological sample, the gene expression data is filtered using signal transduction model information, and filtered gene expression data is generated.

In yet another aspect, an array of data representing gene expression information is received, a filter incorporating coefficients representing at least one signal transduction pathway model is applied to the array, and the filtered array of data is outputted.

Further, in another aspect, a system is provided in which a microarray reader identifies gene expression information from at least one microarray. A microprocessor calculates a current gene expression information estimate as a function of the read gene expression information, employing at least one matrix containing coefficients representing signal transduction information.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of a method of reducing the noise content of molecular diagnostic signals according to one embodiment.

FIG. 2 is a block diagram of a Kalman filter approach utilizing a signal transduction model in accordance with one embodiment.

FIG. 3 is a flow chart of a method of one embodiment.

FIG. 4 is a block diagram of a system in accordance with an embodiment.

### DETAILED DESCRIPTION OF THE DRAWINGS AND THE PRESENTLY

### PREFERRED EMBODIMENTS

Within a clinical setting, one may have knowledge of the genes involved in a specific disease, and the underlying associations between these genes. These underlying associations between identified genes can be expressed as a pertinent signal transduction network. Given this knowledge, one can mathematically model the structure of the associations (e.g. using a Bayesian network) and estimate the coefficients of the model structure (e.g. the conditional probabilities). As discussed below in conjunction with the disclosed embodiments, these models can be used to remove noise from the gene expression signals if they are embedded within a filtering mechanism.

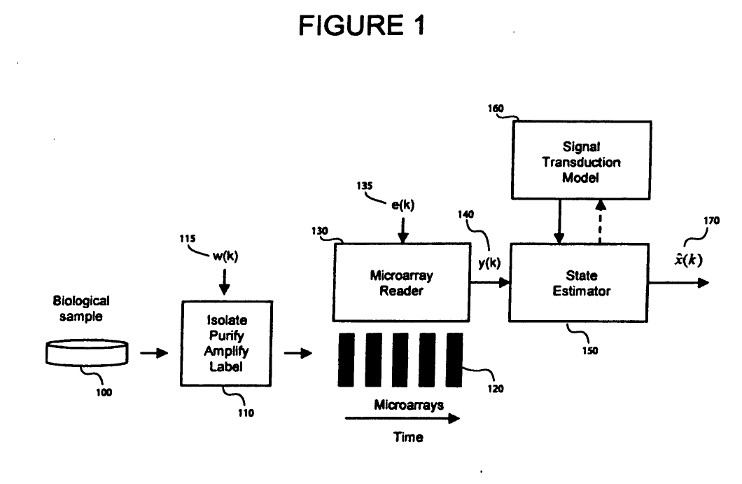

An embodiment incorporating the use of multiple microarrays over time is shown in FIG. 1. First, a biological sample 100 is obtained. The sample may consist of any type of cells containing DNA information. For example, the biological sample 100 prepared from blood, bone marrow, or a tissue obtained from a biopsy. A single sample or multiple sequential samples may be used.

After obtaining the sample 100, hybridization of the processed sample to a microarray is performed in act 110. This consists of isolating mRNA, purifying and reverse-transcribing the mRNA to cDNA. Depending on the microarray platform, amplified cDNA or cRNA is labeled for hybridization to microarrays. This process yields one or more hybridized microarrays 120. However, whenever samples are hybridized to a microarray, a certain amount of process noise 115 is introduced. This process noise 115, denoted as w(k), is introduced when act 110 is performed at time k.

The microarray 120 is then read by the microarray reader 130. The microarray reader examines the gene expression levels contained in the microarray 120 and yields a gene expression vector 140, denoted as y(k). The act of reading the microarrays 120 also introduces noise into the system. When reading the microarrays, measurement noise 135, denoted as e(k), is introduced due to approximation to output discrete numerical values, errors arising from signal processing performed by the microarray reader 130, and fluctuations of the reader's photomultiplier tube.

In order to eliminate or reduce errors introduced by the process noise 115 and measurement noise 135, the gene expression vector 140 is inputted to the state estimator 150. The state estimator 150 filters the gene expression vector 140 utilizing a signal transduction model 160 and outputs a gene expression level estimate 170, \hat{x}(k). Instead of merely averaging numerous samples to reduce process and measurement noise, the state estimator 150 conducts a probabilistic analysis based on one or more signal transduction pathway models. Thus, the numeral values contained in the gene expression vector can be filtered using one or more matrices, or other numerical representations of one or more signal transduction pathways. In this regard, the state estimator 150 performs dynamic error reduction based on how certain gene expression levels are known to correlate or change under different conditions.

The output of the state estimator 150 may also be used to determine if there is a drift of parameters in the signal model. For example, in some biological signal transduction pathways, the signal transduction model will change over time. Accordingly, an adaptive state estimator 150 may be implemented in which these changes can be tracked. As represented in FIG. 1, the dashed arrow from state estimator 150 to the signal transduction model 160 depicts how the output of the state estimator 150 may be applied back to the signal transduction model 160 to account for such changes.

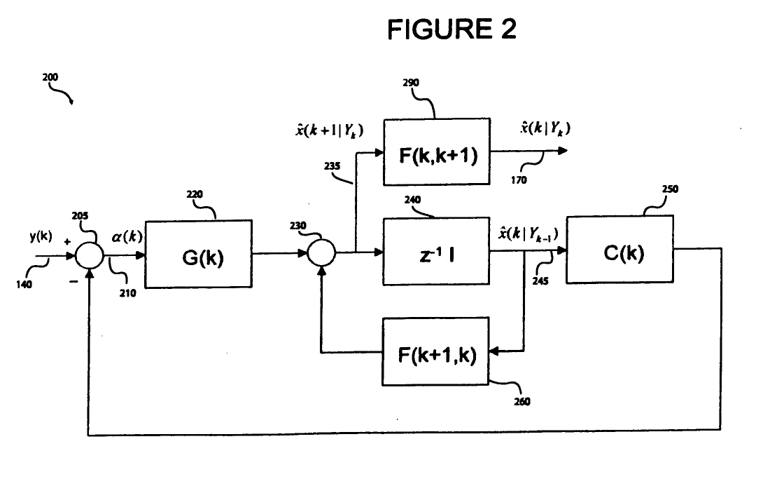

As shown in FIG. 2, one method of implementing the state estimator 150 and signal transduction model 160 is through the use of a Kalman filter 200. Components of the Kalman filter include a Kalman gain matrix 220, a single-step time-delay 240, a measurement matrix 250, a first state transition matrix 260, and a second state transition matrix 290, which is the inverse of or related to the first state transition matrix.

In this embodiment, the gene expression vector 140 is inputted into the filter 200. The previous gene expression estimate (generated by the measurement matrix 250) is subtracted from the gene expression vector by the comparator 205. The result 210 is then applied to the Kalman gain matrix 220. The output of the Kalman gain matrix is then applied to adder 230, which also receives the output of the first state transition matrix 260.

The adder 230 outputs \hat{x}(k+1|Yₖ), the k+1 minimum mean-square gene expression estimate 235. The k+1 minimum mean-square gene expression estimate 235 is then applied to the second state transition matrix 290 and delay 240. The delay 240 outputs \hat{x}(k−1|Yₖ), the k−1 minimum mean-square gene expression estimate, which is in turn inputted into the measurement matrix 250. The second state transition matrix outputs \hat{x}(k|Yₖ), the time k minimum mean-square estimate of the gene expression levels 170. The time k minimum mean-square estimate 170 provides a current estimate of gene expression levels given previous and current measured gene expression data.

The block diagram of FIG. 2 depicts a Kalman filter implementation of a state estimator 150 and signal transduction model 160. The Kalman filter can be implemented using a variety of methods including both hard-wired circuitry and/or through software running on a microprocessor. As is well known from the literature (e.g. see Haykin), the minimum mean-square estimate \hat{x}(k|Yₖ) of the pertinent gene expression levels can be computed utilizing the following standard Kalman filter recursion equations:
G(k)=F(k+1, k)K(k, k−1)C^{H}(k)[C(k)K(k,k−1)C^{H}(k)+Q₂(k)]⁻¹
α(k)=y(k)−C(k)\hat{x}(k|Yₖ₋₁)
\hat{x}(k+1|Yₖ)=F(k+1,k)\hat{x}(k|Yₖ₋₁)+G(k)α(k)
\hat{x}(k|Yₖ)=F(k,k+1)\hat{x}(k+1|Yₖ)
K(k)=K(k, k−1)−F(k,k+1)G(k)C(k)K(k,k−1)
K(k+1,k)=F(k+1,k)K(k)F^{H}(k+1,k)+Q₁(k)
where Q₁(k) is the correlation matrix of process noise w(k), and Q₂(k) is the correlation matrix of measurement noise e(k).

The state transition matrix F(k+1, k) captures the dynamics of the pertinent signal transduction network and can be modeled by any of a number of schemes, such as a dynamic Bayesian network. The filtered expression levels contained in the estimated gene expression vector \hat{x}(k|Yₖ) can be used with a plurality of pattern classification schemes to develop clinical diagnostic tools. If the signal transduction pathways and the characteristics of the reader are accurately modeled, the use of \hat{x}(k|Yₖ) increases the sensitivity and/or specificity of the diagnostic tool over what one would obtain by using the noisy gene expression signals y(k).

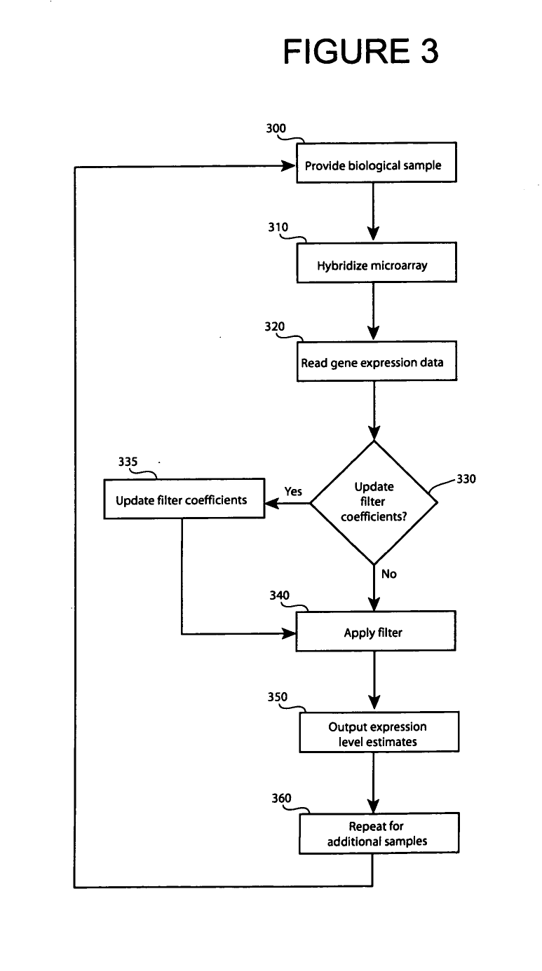

FIG. 3 shows a flowchart for an embodiment using dynamic state estimation. In act 300, a biological sample is created. Several different methods of creating the biological sample may be utilized. The biological sample can be acquired from a multitude of sources, e.g. blood sample or biopsy, and processed in several different ways. In one method, mRNA is first isolated from the cells of interest. The RNA is then reverse-transcribed to cDNA, amplified and labeled, typically with a fluorphore. The amplified and labeled nucleic acid is next mixed with a control sample that has been labeled with a contrasting fluorphore. As described below in connection with act 320, the use of differential labeling assists in distinguishing sample and control during scanning.

In act 310, the pooled nucleic acid from act 300 is hybridized to the microarray 120. This act can be accomplished via any of a number of well-established or later developed laboratory techniques. Multiple biological samples and hybridizations may be prepared contemporaneously or at different times. For example, act 310 may comprise the act of hybridizing several microarrays at one time. Alternatively, act 310 may consist of hybridizing a single microarray. Further yet, act 310 may be repeated to create several hybridizations that account for changes in biological samples that may have taken place over time, biological samples procured at different times, or different types of biological samples.

In act 320, the microarray 120 is read by a microarray reader 130 to obtain gene expression data 140. In one embodiment, the microarray is scanned by a dual laser confocal microscopic to measure the intensity of light emitted by each fluorphore. The relative intensities of the fluorphores correspond to the relative abundance of sample and control mRNA. Thus, from these readings, one can quantify the degree to which each gene represented on the microarray was up-regulated or down-regulated in the sample relative to the control. Various techniques for reading microarrays are commercially available from companies such as Axon Instruments. Other now known or later developed techniques may be used. In another embodiment, the microarray is scanned as above, but without a control sample, to obtain an absolute measure of gene expression, as is typically performed with oligonucleotide microarrays commercially available from companies such as Affymetrix.

In act 330, the system examines whether filter coefficients used in the first and second transition matrix, Kalman gain matrix, and/or measurement matrix, should be updated depending on environmental conditions, time lapse, or any other factor that might make it desirable to adjust the values of the signal transduction model 160. Act 330 may be omitted, such as if a non-adaptive filter is desired.

If the system determines that the filter coefficients should not be updated or after any update, the filter is applied in act 340. In accordance with the embodiment of FIG. 2, act 340 may comprise application of the inputted gene expression vector 140 into the Kalman filter 200. The Kalman filter 200 utilizes a model of the signal transduction network expressed by the state transition matrix 260 and the inverse state transition matrix 290 to output a gene level estimate 170. In this regard, removal of noise from gene expression signals may be effected through recursive Kalman filtering and redundancies in the gene expression signals of the multivariate gene expression assays.

The gene expression level estimates are outputted in act 350. The process is then repeated (act 360) until no further microarray readings are taken. The number of microarray readings is discretionary. Further, one could utilize a filtering arrangement in which only one microarray reading is filtered. For example, the Kalman filter implementation of FIG. 2 could be applied in a reduced implementation using one microarray reading and the method of FIG. 3 could be performed without act 360.

Returning to act 330, if the system determines that the filter coefficients should be updated, the filter coefficients are updated in act 335. The updating of the filter coefficients allows the filter to account for changes in the model parameters. By implementing parameter estimation methods as well as signal filtering (act 340), changes in the parameters can be detected and filter coefficients can be adjusted accordingly. In this sense, an adaptive filter is implemented. For example, in the case of a Bayesian network, conditional probabilities adapt to gradual changes in signal transduction associations as could occur over the course of a chronic illness or disease.

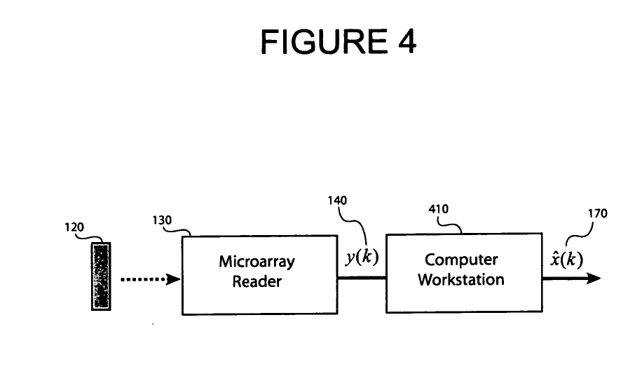

Referring to FIG. 4, a block diagram for a system in accordance with an embodiment of the present invention is depicted. In the system, one or more microarrays 120 are read by a microarray reader 130, which outputs a gene expression vector 140. A computer workstation 410, connected with the microarray reader 130, filters the gene expression vector using a software-driven state estimator 150 that utilizes a mathematical representation of a signal transduction model 160. Alternatively, a general processor, digital signal processor, field programmable gate array, application specific integrated circuit, digital circuit, analog circuit, computer controller or combination thereof implements the state estimator 150. The model 160 is stored in a memory, such as a cache, RAM, ROM, hard drive, flash memory, removable memory card, or other memory storing device.

The computer workstation 410 utilizes a numerical representation of the biological system (i.e. a network model of the signal transduction pathway) to filter a non-stationary input signal (i.e. the gene expression vector 140). The filter coefficients may be adapted, as discussed above, to adapt the filter coefficients to estimate the conditional probabilities of the modeled signal transduction pathway. Further, by repeating the processes, one can recursively estimate gene expression levels through analysis of successive microarrays over time. Thus, a dynamic filtering mechanism based on the knowledge of the underlying molecular mechanisms may be implemented to reduce the noise content of gene expression signals. In turn, these signals may then be used in conjunction with a pattern classification system for the purpose of medical diagnosis. By reducing the noise content in the gene expression signals, increased specificity and sensitivity of the diagnosis may be achieved.

While the invention has been described above by reference to various embodiments, it should be understood that many changes and modifications can be made without departing from the scope of the invention. For example, in addition to DNA microarrays, protein microarrays may be used in other embodiments. Further, although Kalman filtering techniques have been discussed, other estimation techniques may be used. Also, when Kalman filtering is used, the Kalman filter may be modified to address nonlinearities in the signal transduction network.

It is therefore intended that the foregoing detailed description be regarded as illustrative rather than limiting, and that it be understood that it is the following claims, including all equivalents, that are intended to define the spirit and scope of this invention.

1. A method for filtering molecular diagnostic signals comprising:
hybridizing a microarray;
inputting a gene expression sample, the gene expression sample including gene expression information; and
filtering the gene expression sample utilizing signal transduction model information, the signal transduction model information including a mathematical representation of at least one biological signal transduction pathway; and
outputting, a filtered gene expression sample.

2. The method of claim 1 further comprising the act of reading gene expression information with a microarray reader.

3. The method of claim 1 wherein the gene expression information comprises a vector.

4. The method of claim 1 wherein the gene expression information comprises a matrix.

5. The method of claim 1 wherein the signal transduction model information is expressed in one or more matrices.

6. A method for filtering molecular diagnostic signals comprising:
providing signal transduction model information the signal transduction model information including a mathematical representation of at least one biological signal transduction pathway;
providing a biological sample;
obtaining gene expression data from the biological sample;
filtering the gene expression data utilizing the signal transduction model information; and
outputting filtered gene expression data.

7. (canceled)

8. (canceled)

9. The method of claim 6 wherein the act of filtering the gene expression data comprises the acts of:
providing the gene expression data to a state estimator; and
performing dynamic error reduction using a matrix-based representation of relationships of gene expression levels.

10. The method of claim 9 wherein the matrix-based representation of relationships is a numerical representation of a signal transduction network.

11. A method for filtering molecular diagnostic signals comprising:
providing a gene expression vector, the gene expression vector including gene expression data obtained from a biological sample;
filtering the gene expression vector utilizing at least one signal transduction network model, the signal transduction model including a mathematical representation of at least one biological signal transduction pathway; and
outputting the filtered gene expression vector.

12. A method for reducing the noise content of molecular diagnostic signals comprising:
receiving an array of data, the array representing gene expression information;
applying a filter to the array of data, the filter incorporating coefficients representing at least one signal transduction pathway model; and
outputting a filtered array of data

13. The method of claim 12 wherein the filter is a Kalman filter.

14. The method of claim 12 wherein the filtered array of data is a minimum mean-square estimate of gene expression levels.

15. The method of claim 12 wherein the filter utilizes a previously received array of data to provide an estimate of gene expression levels.

16. The method of claim 12 wherein the filter is recursive.

17. The method of claim 12 wherein the filter comprises a state estimator.

18. The method of claim 12 further comprising the act of updating filter coefficients.

19. The method of claim 18 wherein the act of updating filter coefficients comprises utilizing the output of the filter to identify variation in the signal transduction model.

20. The method of claim 18 wherein the filter is a state estimator.

21. A system for reducing noise from a gene expression array, the system comprising:
a microarray reader, the microarray reader operable to identify gene expression information from at least one microarray;
a microprocessor;
wherein the microprocessor calculates a current gene expression information estimate as a function of the gene expression information and at least one matrix containing coefficients representing signal transduction information.

22. The system of claim 21 further comprising one or more memories connected with the microprocessor and operable to store (a) data corresponding to the gene expression information received from the microarray reader, (b) data corresponding to at least one matrix of coefficients representing signal transduction information, and (c) data corresponding to a current gene expression information estimate.

23. The system of claim 22, where the one or more memories are further operable to store (d) data containing a previous estimate of gene expression information, and wherein the microprocessor utilizes the data containing the previous estimate of gene expression information to provide the current estimate of gene expression information.

24. The method of claim 6 wherein the gene expression data comprises a gene expression vector, the act of filtering the gene expression data utilizing signal transduction model information comprises inputting the gene expression vector into a Kalman filter, and the numerical representation of at least one biological signal transduction pathway comprises a state transition matrix.
